(19) United States
(12) Patent Application Publication
(10) Pub. No.: US 2016/0219266 A1
(43) Pub. Date: Jul. 28, 2016

(54) ANATOMICAL IMAGING SYSTEM FOR PRODUCT CUSTOMIZATION AND METHODS OF USE THEREOF

(71) Applicant: 3dMD Technologies Ltd, London (GB)

(72) Inventor: Christopher Ronald Lane, Atlanta, GA (US)

(73) Assignee: 3dMD Technologies Ltd, London (GB)

(21) Appl. No.: 15/005,888

(22) Filed: Jan. 25, 2016

Related U.S. Application Data
(60) Provisional application No. 62/107,472, filed on Jan. 25, 2015.

(51) Int. Cl. H04N 13/02; B29C 67/00; G05B 19/4099; G06T 7/00

(52) U.S. Cl. CPC H04N 13/0282; H04N 13/0296; H04N 13/0253; G06T 7/0073; H04N 13/0257; B29C 67/0088; G05B 19/4099; G06T 2207/10028; G06T 2207/30196; G05B 2219/35134; G05B 2219/49007; B33Y 50/02

(57) ABSTRACT

Anatomical imaging in short time periods (typically measured in seconds) for use in customization of products. In some embodiments, a 3D foot imaging systems that can be used for 3D printing of footwear.

### RELATED PATENT APPLICATIONS

This Application claims priority to U.S. patent application Ser. No. 62/107,472, entitled “Anatomical Imaging System For Production Customization And Methods of Use Thereof,” filed on Jan. 25, 2015, which is commonly owned by the owner and applicant of the present invention and is incorporated by reference herein in its entirety.

### FIELD OF INVENTION

The present invention relates to anatomical imaging systems for use in product customization, such as 3D foot imaging systems.

### SUMMARY OF THE INVENTION

The present invention relates to anatomical imaging in short time periods (typically measured in seconds) for use in customization of consumer products. While the anatomic features can be diverse, the present summary focuses on those involving 3D foot imaging systems; however, the present invention is not limited to only feet and shoe apparel.

Various devices for extracting foot measurements and for rendering a 3D model have been developed over the past 15 years. Most have had relatively long image capture (scanning) times and have been unable to both capture a foot on a flat surface and the unconstrained last of the foot. The episode of interaction with the subject to be measured has been generally long and the resultant reliability of measurements questionable. With the emergence of 3D printing and mass customization, there is now a need for individual 3D models of a subject's foot in a variety of positions including the last, flat surface spread and potentially toe and ankle articulation. In order to progress the production technology large numbers of individual data needs to be collected and ultimate it may be necessary to image consumers prior to purchase. Thus, there needs to be an efficiency of imaging work flow and economics not previously contemplated.

The present invention allows retail stores to scan feet to build a substantive database of consumer data. The retail store can then provide visual matching to existing inventory. Moreover, the collected database can be utilized for improve production inventory and for development and production techniques. Furthermore, retail stores can direct fulfillment from the customer foot image to product fulfillment on a customized basis.

The present invention can include the following:

A simple action by subject, similar to a step into the imaging system

3D imaging of the foot at 10-15 frames per second triggered and terminated by sensors.

Select the best images for rendering and usage, e.g., foot at rest, foot in motion.

Basic imaging interaction to last no more than 2 seconds per foot.

Provide results available within 1 minute.

An electronic chassis and physical structured separated, with the latter customized by the service provider or retail store.

Obtain data that will have persistent long term value be capable of fulfills likely needs for many years forward.

Embodiments of the present invention encompass a foot capture device using 3D imaging system using 3D imaging of 3dMD LLC. The system is semi-dynamic (approximately 10 3D fps), and can capture the 360° dynamics of a step from the upper and lower perspectives. The system would capture a shoe last in free form as well as against a flat transparent surface. This would permit the system to see the ankle dynamics and how the ball of the foot and heal spreads with weight distribution. The system would also allow simple mobility exercises. There would have textured and non-textured options possible. The system is capable of extracting information that would be presentable to the consumer within a couple of minutes. Such information can be used in product fulfillment both on existing inventor, as well as customized products such as 3D printing of shoes (such as athletic shoes). Accordingly, in one embodiment, the 3D imaging system is coupled to a computer and a 3D printer so that a footwear can be manufactured utilizing the information obtained from the 3D imaging system while the consumer waits.

In general, in one aspect, the invention features a system that includes an imaging system. The imaging system includes a plurality of modular camera units. Each modular camera unit includes a first machine vision camera, a second machine vision camera, and a projector to provide light. A system further includes a processor coupled to the imaging system. The system further includes a memory unit operable for storing an imaging computer program for operating the imaging system. The imaging computer program includes the step of sending and receiving signals to control each of the plurality of modular camera units as an object passes before the imagining system to generate stereo images of the object obtained from both of the first machine vision camera and the second machine vision camera of the modular camera unit while controlling the light emitted from the projector of the modular camera unit. The object is an anatomical portion of a person. Data to construct each 3D image is obtained by the modular camera unit in the plurality of modular camera units in a range of 0.5 to 5 milliseconds. The imaging computer program further includes the step of generating stereo images from the data obtained from the plurality of modular camera units. The imaging computer program further includes the step of performing active stereophotogrammetry to calculate a 3D surface image of the object from the generated stereo images.

Implementations of the invention can include one or more of the following features:

The step of performing active stereophotogrammetry can calculate a sequence of 3D surface images of the object from the generated stereo images.

The first machine vision camera can be monochromatic. The second machine vision camera can be monochromatic.

At least some of the modular camera units in the plurality of modular camera units can further include a color camera.

The imaging system can further include the modular camera units generates the stereo images at a stereo image generation rate of 10 to 60 frames per second.

The stereo image generation can be 10 to 15 frames per second.

The object can be a foot of the person.

The system can further include a platform. At least a portion of the platform can be a transparent surface. The platform can be made of one or more materials that are capable of being walked upon by the person. At least two of the plurality of modular camera units can be positioned above the platform and arranged to view the foot of the person as the person walks across the platform. At least one of the plurality of the modular camera units can be positioned below the platform and arranged to view the foot of the person as the person walks across the transparent surface.

At least four of the plurality of modular camera units can be positioned above the platform and arranged to view the foot of the person as the person walks across the platform

At least one of the plurality of the modular camera units positioned below the platform can be arranged to view the foot of the person as the person walks across the transparent surface by reflection of an angled mirror positioned below the platform.

The imaging computer program can further include the step of sending signals transmitting at least one 3D surface image of the object to a manufacturer to manufacture a footwear product.

The imaging computer program can further include the step of sending signals transmitting at least one 3D surface image of the object to an additive manufacturing process device to manufacture a footwear product.

The system can further include an additive manufacturing processing device operatively connected to the processor. The additive manufacturing process device can include a 3D printer.

The object can be (i) a foot, (ii) a hand, (iii), a woman's prosthetic breast, or (iv) a combination thereof.

The imaging computer program can further include the step of sending signals transmitting at least one 3D surface image of the object to a manufacturer to manufacture a footwear product.

The imaging computer program can further include the step of sending signals transmitting at least one 3D surface image of the object to an additive manufacturing process device to manufacture the footwear product.

The system can further include an additive manufacturing processing device operatively connected to the processor. The additive manufacturing process device can be a 3D printer.

The first machine vision camera can be monochromatic. The second machine vision camera can be monochromatic. The projector can be a white light speckle projector. Each of the modular camera units in the plurality of modular camera units can further include a color camera and an external white light flash unit. The imaging computer program can further include sending signals to simultaneous trigger the white light speckle projector of the modular camera unit with the first machine vision camera and the second machine vision camera of the modular camera unit. The imaging computer program can further include sending signals to simultaneous trigger the color camera and the external white light flash unit 0.1 to 2 milliseconds after the simultaneous triggering of the white light speckle projector, the first machine vision camera, and the second machine vision camera of the modular camera unit.

The imaging system can be a portable device.

In general, in another aspect, the invention features a method that includes directing the movement of an object across an imaging system. The imaging system includes a plurality of modular camera units. Each modular camera unit includes a first machine vision camera, a second machine vision camera, and a projector to provide light. The object is an anatomical portion of a person. The method further includes using the plurality of modular camera units to generating stereo images. The data to construct each 3D image used to generate the stereo images is obtained by the modular camera units in the plurality of modular camera units in the range of 0.5 to 5 milliseconds. The method further includes using the generated stereo images to perform active stereophotogrammetry and calculate a 3D surface image of the object.

Implementations of the invention can include one or more of the following features:

The step of using the generated stereo images can include performing active stereophotogrammetry to calculate a model of the 3D surface image of the object.

The first machine vision camera can be monochromatic. The second machine vision camera can be monochromatic.

At least some of the modular camera units in the plurality of modular camera units can further include a color camera.

The imaging system can further include using the modular camera units to generate the stereo images at a stereo image generation rate of 1 to 60 frames per second.

The object can be a foot of the person.

The imaging system can further include a platform. At least a portion of the platform can be a transparent surface. The platform can be made of one or more materials that are capable of being walked upon by the person. At least two of the plurality of modular camera units can be positioned above the platform and arranged to view the foot of the person as the person walks across the platform. At least one of the plurality of the modular camera units can be positioned below the platform and arranged to view the foot of the person as the person walks across the transparent surface.

At least four of the plurality of modular camera units can be positioned above the platform and arranged to view the foot of the person as the person walks across the platform

At least one of the plurality of the modular camera units positioned below the platform can be arranged to view the foot of the person as the person walks across the transparent surface by reflection of an angled mirror positioned below the platform.

The step directing the movement of an object across an imaging system can include having the person walk across the platform in a first direction and placing one foot on the transparent surface. The step directing the movement of an object across an imaging system can further include having the person turn around and walk across the platform in the opposite direction and placing the opposite foot on the transparent surface.

The step directing the movement of an object across an imaging system can include having the person walk upon the platform in a first direction and placing one foot on the transparent surface. The step directing the movement of an object across an imaging system can further include having the person walk upon the platform in the first direction and placing the opposite foot on the transparent surface.

The method can further include sending the at least one 3D surface image of the object to a manufacturer to manufacture a footwear product.

The method can further include using an additive manufacturing process to manufacture a footwear product using at least one 3D surface image of the object.

The additive manufacturing process can include a 3D printing process.

The object can be (i) a foot, (ii) a hand, (iii), a woman's prosthetic breast, or (iv) a combination thereof.

The method can further include sending the at least one 3D surface image of the object to a manufacturer to manufacture a footwear product.

The method can further include using an additive manufacturing process to manufacture a footwear product using at least one 3D surface image of the object.

The additive manufacturing process can include a 3D printing process.

The first machine vision camera can be monochromatic. The second machine vision camera can be monochromatic. The projector can be a white light speckle projector. Each of the modular camera units in the plurality of modular camera units can further include a color camera and an external white light panel unit. The step of using the plurality of modular camera units to generate stereo images can include simultaneously triggering the white light speckle projector of the modular camera unit with the first machine vision camera and the second machine vision camera of the modular camera unit. The step of using the plurality of modular camera units to generate stereo images can further include simultaneous triggering the color camera and the external white light panel unit 0.1 to 2 milliseconds after the simultaneous triggering of the white light speckle projector, the first machine vision camera, and the second machine vision camera of the modular camera unit.

The imaging system can be a portable device.

### DESCRIPTION OF DRAWINGS

FIG. 1 is illustration of prospective frontal view of an imaging system that can be used to image a foot.

FIG. 2 is an illustration of a prospective side view of the imaging system shown in FIG. 1.

FIG. 3 is an illustration of a side view of the imaging system shown in FIG. 1.

FIG. 4 is an illustration of another prospective side view of the imaging system shown in FIG. 1.

FIG. 5 is an illustration of one pair of machine vision cameras utilized in the imaging system shown in FIG. 1.

FIG. 6 is a photograph of an imaging system that can be used to image a foot taken from a prospective side view.

FIG. 7 is a photograph of the imaging system shown in FIG. 5 taken from an another prospective side view.

FIG. 8 is illustration of a prospective side view showing the internal frame an imaging system that can be used to image a foot.

FIG. 9A is a prospective side view of another imaging system that can be used to image a foot.

FIG. 9B is a prospective side view showing the internal frame the imaging system of FIG. 9A.

FIG. 10A is a prospective side view of another imaging system that can be used to image a foot.

FIG. 10B is a prospective side view showing the internal frame the imaging system of FIG. 10A.

FIG. 11 is illustration of a hand held device that can be used to image a foot.

FIG. 12 is a schematic illustration of an imaging system of the present invention.

FIGS. 13 is a snapshot of a generated 3D image of a foot taken using an imaging system of an embodiment of the present invention. This snapshot was taken from a generated video 3D image of the foot showing its movement over time.

FIG. 14 is an illustration of panels of 3D images from different views of a foot taken using an imaging system of an embodiment of the present invention.

FIG. 15 is another schematic illustration of an imaging system of the present invention that includes a 3D printing device.

### DETAILED DESCRIPTION

### Image Capturing

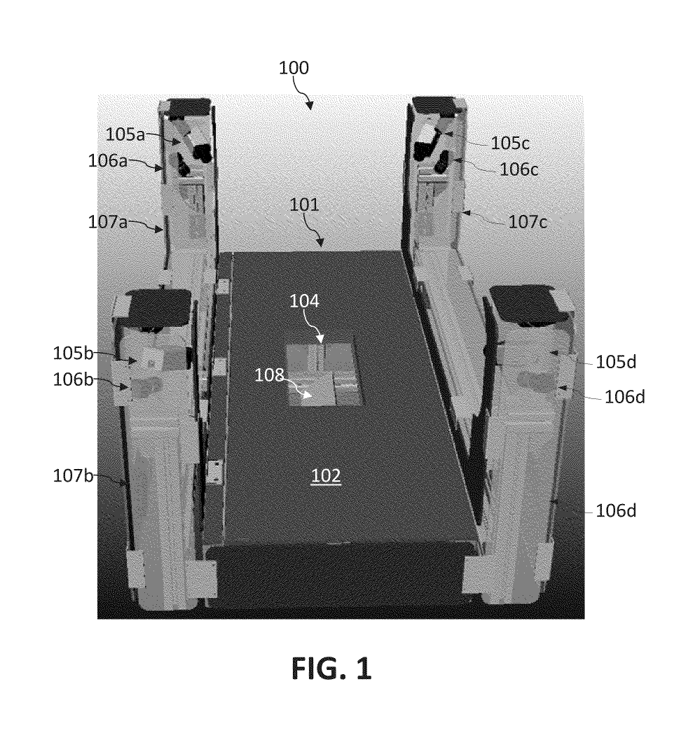

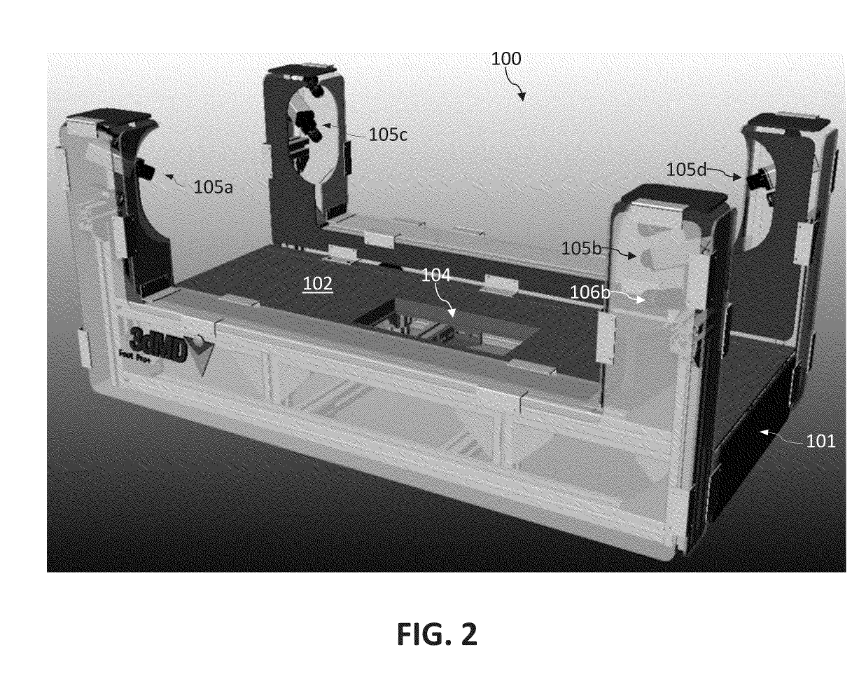

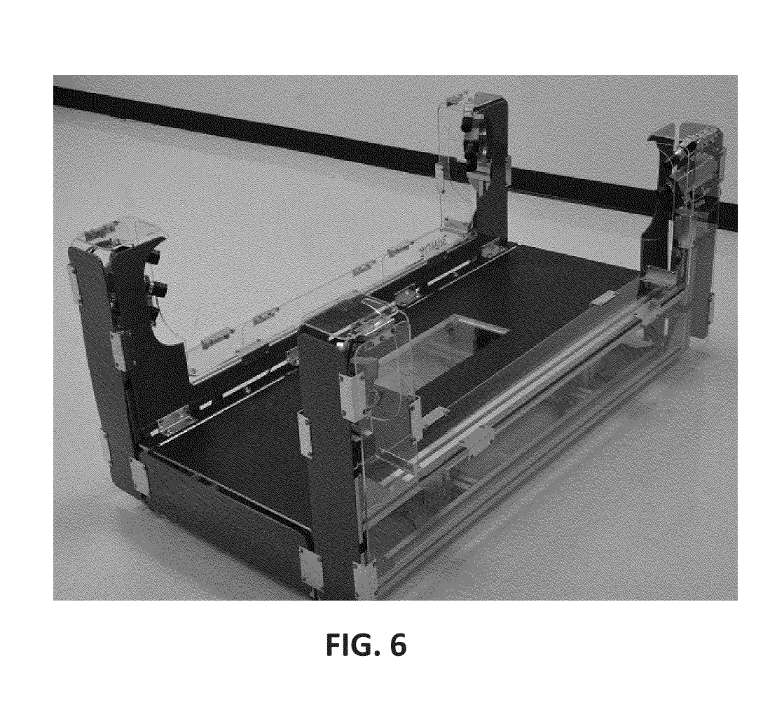

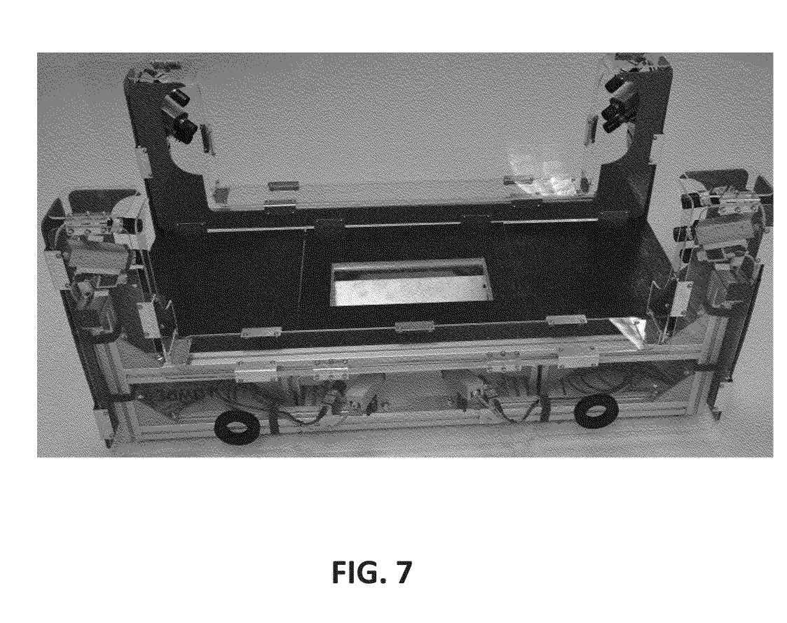

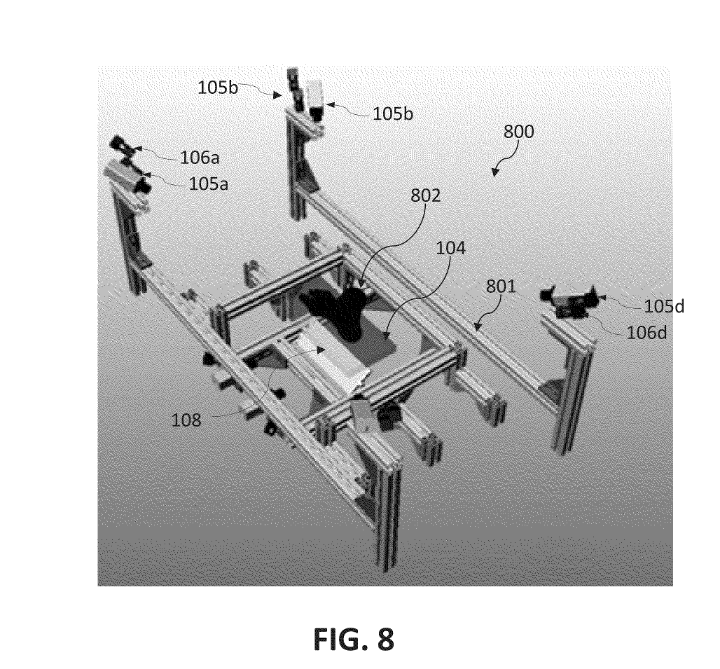

The present invention relates to anatomical imaging systems for use in product customization, such as a 3D foot imaging system. Referring to FIGS. 1-4, these figures illustrate different views of an imaging system 100 that can be used to image a foot (a “foot imaging system”). (FIGS. 6-7 are photographs of such a foot imaging system). The foot imaging system 100 consists of a framework and platform 101. (A framework for the foot imaging system, such as shown in FIG. 8, is discussed in more detail below). The platform 101 can be walked upon. Typically, the platform is about 8 to 10 inches off the ground so one possibility is a simple ramp with footprints on either side allowing the person to walk up for the left and right foot in natural steps. This would take a little more space than a simple platform.

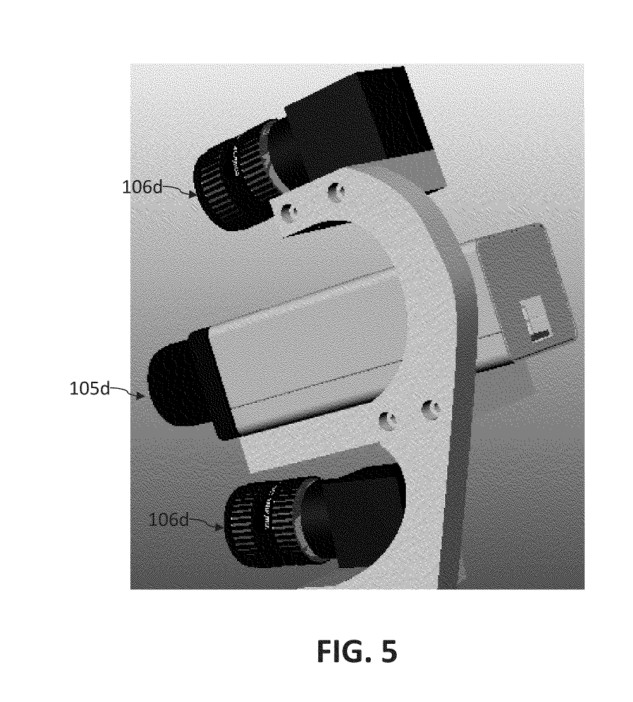

The platform has a portion that is a transparent surface 104. The transparent surface 104 can be made of poly(methyl methacrylate) (PMMA), which is commonly known as Plexiglas, Acrylite, Lucite, and Perspex. The foot imaging system has a plurality of machine vision cameras, such as machine vision camera pairs 106a-106e. (Each pair includes two machine vision cameras). Such machine vision cameras can be 2 Megapixel resolution monochrome machine vision cameras arranged around the platform 104. Some of the plurality of cameras are positioned above platform 104. For instance, as shown in FIGS. 1-4, machine vision cameras 106a-106d are shown near the top portion of frame arms 107a-107d, respectfully. FIG. 5 shows a magnified view of both of the cameras of the camera pair 106d.

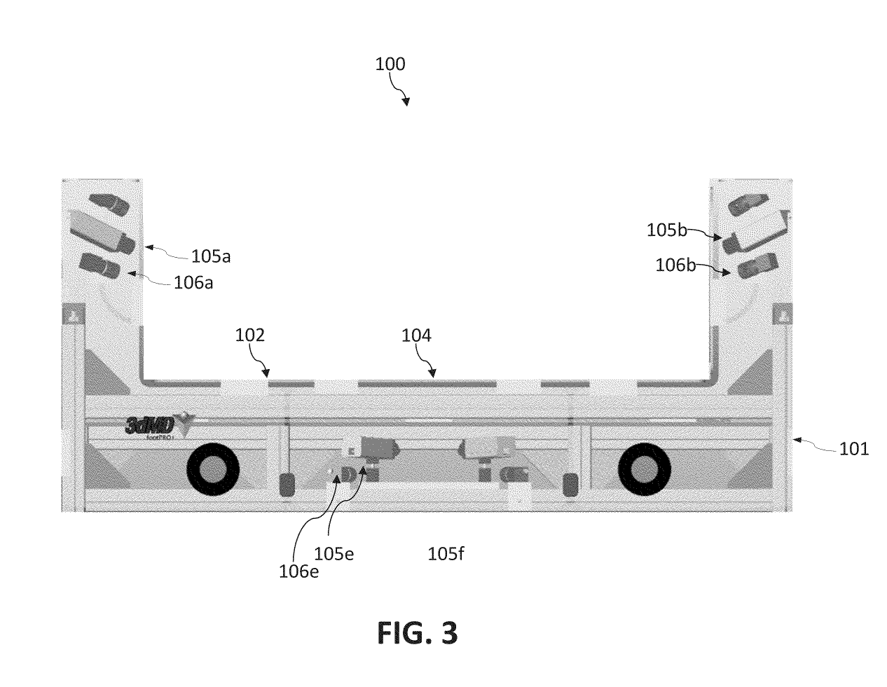

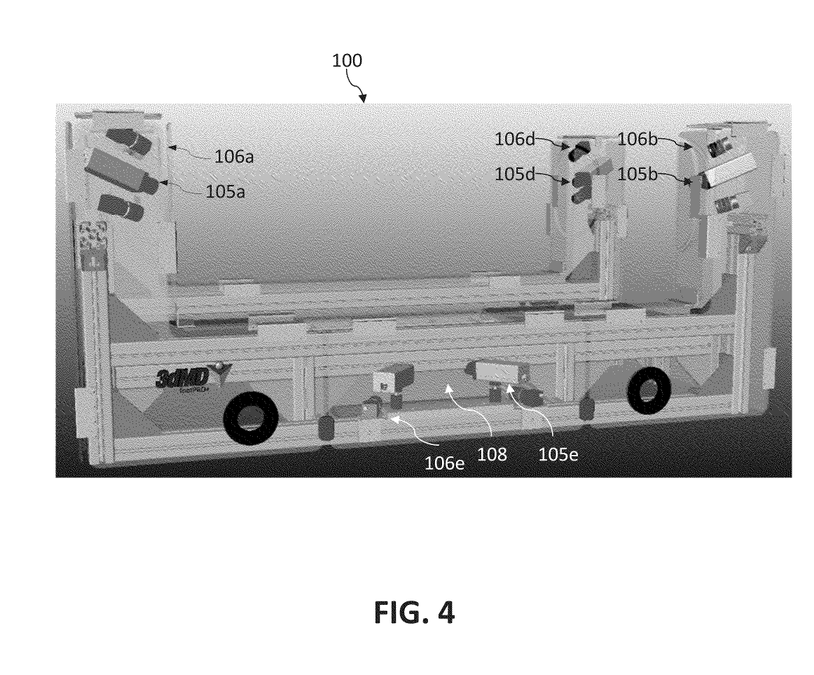

Furthermore, at least one machine vision camera pair (machine vision camera pair 105e) is located beneath the platform 104 and can view upwards through transparent surface 104. For instance, as shown in FIGS. 3-4, machine vision camera pair 106e can view an angle mirror 108.

Each of machine vision camera pairs 106a-106e of cameras is accompanied by an LED projector (projectors 105a-105e, respectively). These projections can contain a lens and etched slide with a random speckle pattern. The combination of machine vision camera pairs (i.e., two cameras) with the projector is referred to herein as the a modular camera units (“MCU”). As discussed below, the MCU can optionally additionally (or alternatively) include a color camera. The embodiments of the invention thus include a plurality of MCUs.

FIG. 8 shows a framework 800 for a foot imaging system. The frame 801 supports platform, the camera pairs, and the projectors, and orients them in the appropriate directions. As shown in FIG. 8, this shows the position of the foot 802 when in contact with transparent surface 104.

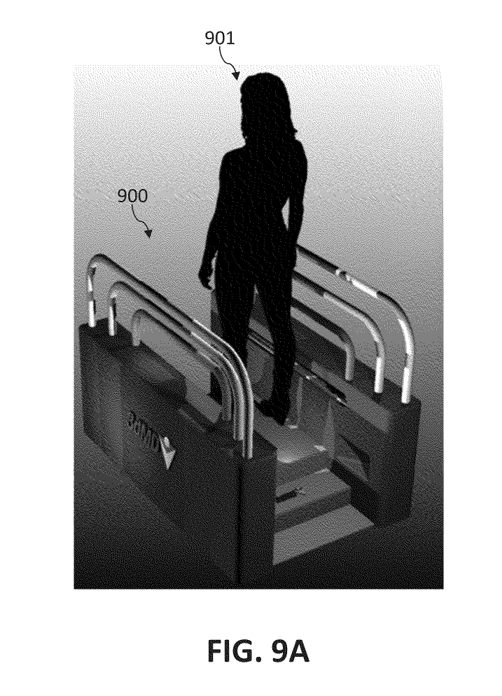

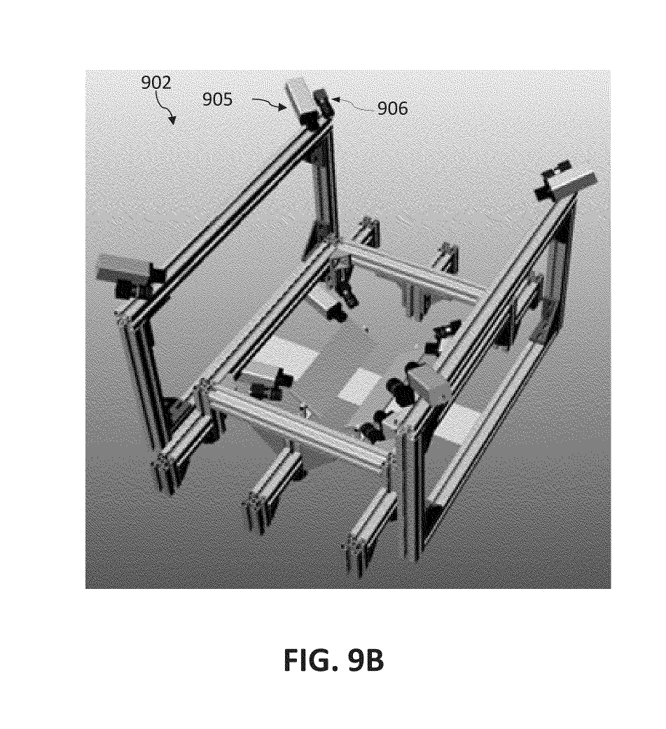

FIG. 9A shows an alternative foot imaging system 900 with a person 901 positioned with the foot on the transparent surface. While the person 901 is illustrated as standing still, in typical operation of the foot imaging system, such person 901 would walk back and forth across the platform while imaging takes place. For instance, when walking in one direction, the person's right foot would step upon the transparent surface, and when walking back in the other direction, the person's left foot would step upon the transparent surface.

FIG. 9B shows frame 902 for foot imaging system 900. This includes machine vision camera pair 906 and projectors 905.

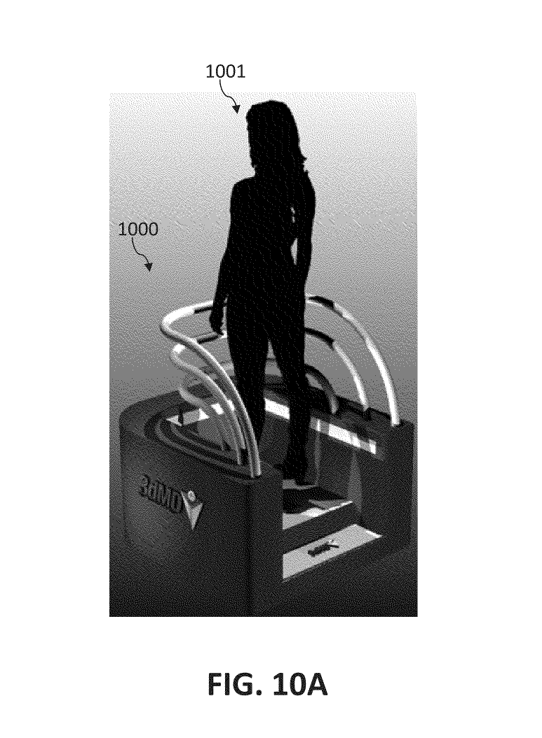

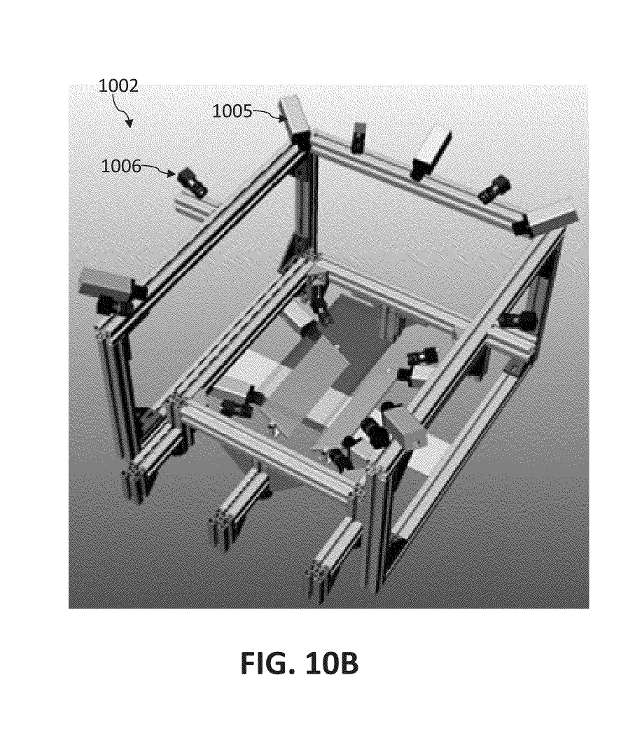

FIG. 10A shows another alternative foot imaging system 1000 with a person 1001 positioned with the foot on the transparent surface. While the person 1001 is illustrated as standing still, in typical operation of the foot imaging system, such person 901 would step up upon the platform while imaging takes place (alternating each foot).

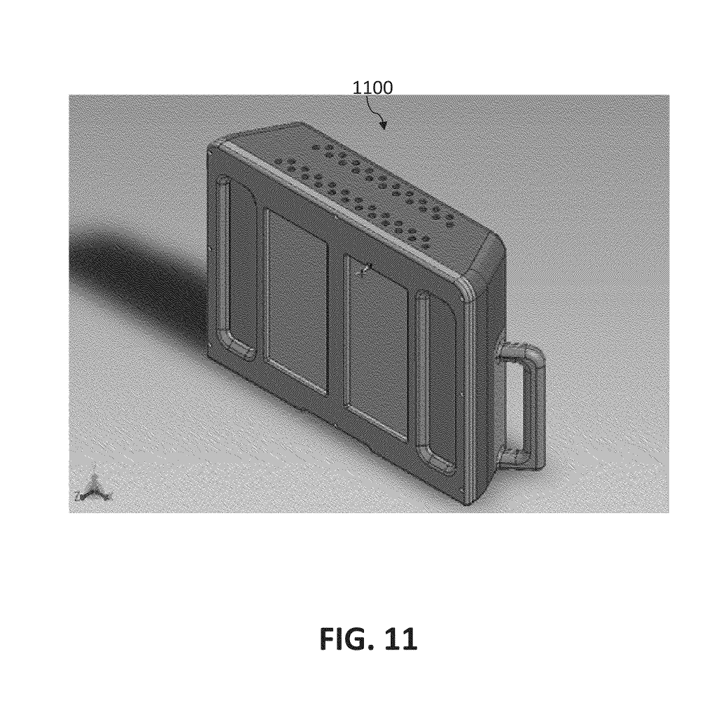

Alternatively, the image system can be a handheld device, such as device 1100 shown in FIG. 11. Such handheld device can include the camera pairs and projectors described above, such as multiple monochrome stereo camera pairs, with each pair with an associated color camera and white light speckle projector.

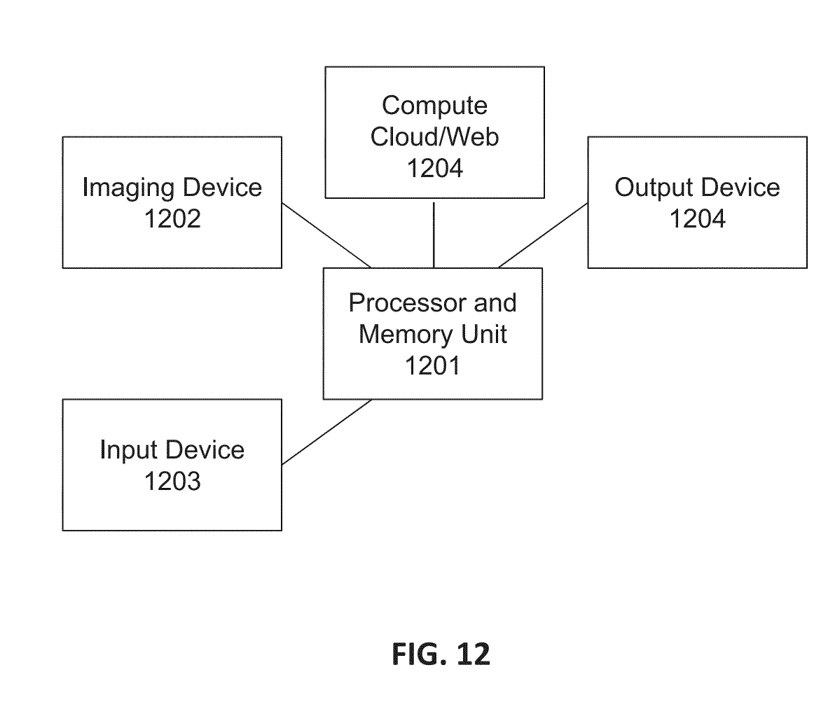

As shown in FIG. 12, the imaging device 1202 (such as foot imaging system 100 described above) is operatively to a processor and memory unit 1201 (such as via a cable or by a wireless connection). This operative connection of imaging device 1202 to processor and memory unit 1201, such as a computer 1201, includes that the cameras pairs (such as machine vision camera pairs 106a-106e) are operatively connected to computer 1201. For instance, machine vision cameras pairs 106a-106 are directly connected to a PC workstation with GigE cables and also to a trigger box. Such operable connection also includes connection to the projectors 105a-105e (which again, for instance, can be a connection to a PC workstation with the GigE cables).

Generally, the imaging device 1202 will require a dedicated computer (at least dedicated during capture and processing phases). This can be am existing PC, laptop or embedded ‘book’ format computer.

Computer 1201 is also operatively connected (such as by cable, wirelessly, etc.) to input devices 1203 (such as a keyboard, touch screen, etc.) and output devices 1204 (such as display). Some devices, such as a tablet, are input/output devices and would both an input device and an output device. Computer 1201 can also be connected operatively to the cloud or web 1204.

For instance, the system shown in FIG. 12 can be a display and computer 1201 can also be used for driving the display and potentially other in-store experiences. Additional tablet devices and mobile devices can easily link to computer 1201.

### 3D Image Generation

The computer 1201 would utilize software to generate 3D images. The 3rd Generation 3D image acquisition of 3dMD LLC (Atlanta, Ga.) (which can be used in embodiments of the present invention) utilizes a sophisticated software-driven technique called active stereophotogrammetry to calculate the 3D surface image from a series of individual photographs generated from the system's array of tightly synchronized machine vision cameras tightly. The 3dMD hardware manifestation incorporates one or more modular camera units (MCUs) (i.e., camera pairs), and external white light flash units (i.e., projectors), positioned around the subject's head to achieve optimal 360-degree surface coverage.

To generate the 3D anatomical shape information, the 3dMD software utilizes the photographs taken with the monochrome stereo cameras in conjunction with the random white light speckle pattern projected on the subject. To produce the associated color texture information the software utilizes the photographs taken with the color cameras in conjunction with the external white light flash units illuminating the subject.

3dMD's active stereophotogrammetry technique software uses stereo triangulation algorithms to identify and match unique external surface features recorded by each pair of monochrome cameras enabling the system to yield a single 3D surface image with shape definition. Once the 3D anatomical shape contour information has been generated, another software algorithm then matches and merges the images from the color cameras to generate a corresponding texture map. The system automatically generates a continuous 3D polygon surface mesh with a single x, y, z coordinate system from all synchronized stereo pairs of the image. Depending on the mode, the resultant 3D image in conjunction with the 3dMD measurement software has been verified to consistently record geometric accuracy of less than 0.2 mm RMS (root mean square).

The 4th Generation 3D Image Acquisition system extends this concept by removing the dependency on a single shot flash system. The two step image capture is preserved but illumination is achieved using LED sources with very fast recycle times. This allows a continuous sequence of alternating light fields between projector to assist active stereophotogrammetry spatial reconstruction and flat white light for authentic texture capture). Alternating strobe rates of 120 HGz have been achieved. This allows camera frame rates to be latched on to a projector/white light pairs. This in turn allows a flexibility to collect data at 3D image rates of 120 3D frames per second or more. Higher frame rates of 60 fps allow dynamic analysis of facial mannerisms. Lower frame rates can be used to simply image captures by allowing the best static image to be extracted from a sequence of natural movement.

Such 3dMD digital video recorder program is installed on computer 1201. For a foot imaging system, the program allows a capture sequence to be started while the subject places his or her foot into the frame of the foot imaging system and aims to step on a target area of the platform (i.e., the transparent surface) and then step out.

For example, using a foot imaging system that can be walked through (such as shown in FIGS. 1-4 and 9A), a person would (a) start at the one end of the system, (b) step up on the platform at this end, (c) walk across the platform to the other end of the platform making sure to place one foot (such as his or her right foot) on the transparent surface, (d) step off the platform at the other end, (e) turn around, (f) step back up on the other end of the platform, (g) walk across the platform to the first end of the platform making sure to place the other foot (such as his or her right foot) on the transparent surface, and (h) step off the platform at the first end.

For further example, using a foot imaging system that can be walked through (such as shown in FIGS. 1-4 and 9A), a person using the foot imaging system would (a) start at the one end of the system, (b) step up on the platform at this end, (c) walk across the platform to the other end of the platform making sure to place one foot (such as his or her right foot) on the transparent surface, (d) step off the platform at the other end, (e) walk around the foot imaging system to return back to the first end of the system, and (f) repeat steps (a)-(d) making sure to place the other foot (such as his or her right foot) on the transparent surface.

Still further for example, a person using a foot imaging system that cannot be walked through (such as shown in FIG. 10A), a person using the foot imaging system could (a) step up on the platform placing their first foot on the transparent surface, (b) step backwards and down off of the platform, and (c) repeat step (a)-(b) making sure to place the other foot on the transparent surface.

During this process the projectors are switched on and off (such as at a rate of 120 Hz) by a sync box (which is part of the projectors) and the cameras fired at a frame rate of up to 14 frames per second (“fps”). The sync box ensures each camera is triggered against a full illumination cycle of the projector.

For the 3dMD program, 60 3D frames per second for several minutes of capture at highest resolution provides the ultrafast capture speed. The system can provide high-precision with a linear accuracy range of 0.5 mm or better.

The data can then be viewed and analyzed using the 3dMDperform application of the 3dMD software and the sequence of data of the foot processed by 3dMDstereo application of the 3dMD software to produce a sequence of rendered 3D images using active stereo photogrammetry. The algorithms utilized in 3dMD's software allows the fully weighted foot to be identified automatically.

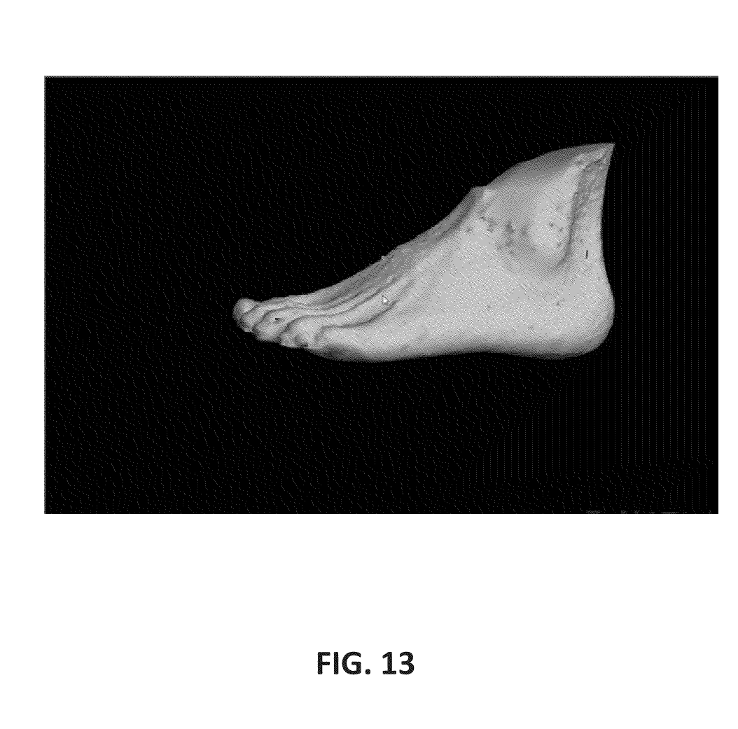

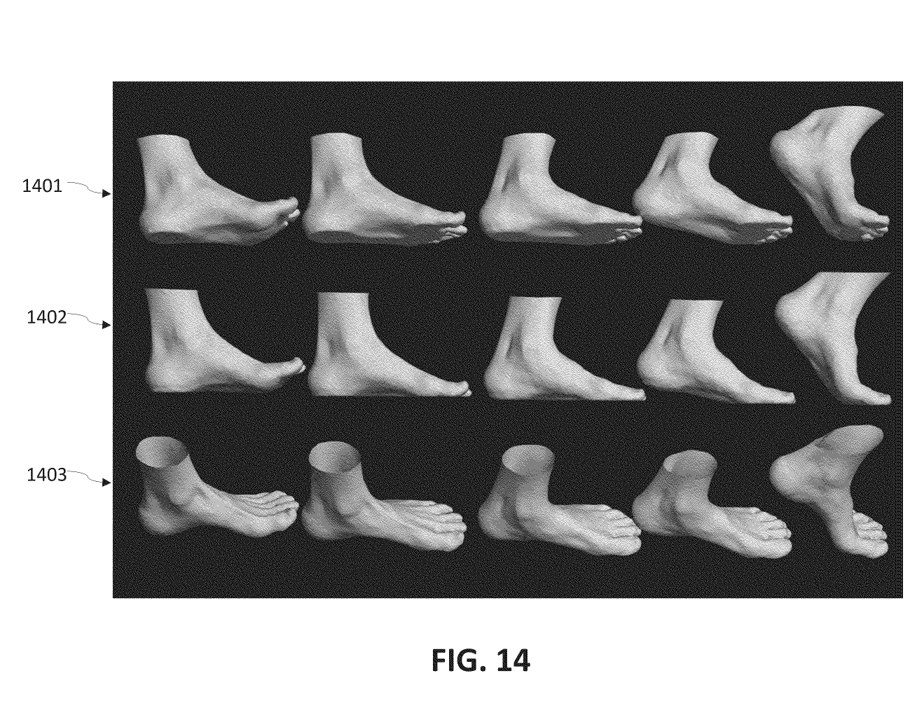

Generally each step creates 10 to 15 useable 3D models of the foot that can be output in any standard 3D format (e.g., .obj and .stl files). For instance, a video can be created showing a 3D image of the foot as it moves. A snapshot image of this is shown FIG. 13. The system may also be customized to provide with a range of side panels 1401-1403 shown in FIG. 14, each showing different views of the foot as it moves over time (as the foot images of side panels 1401-1403) progress over time.

The dimensions of the framework and also camera and projector situation can be varied depending on the protocol required to capture the foot. For instance, the frame rate is determined by the specification and camera being used and can be up to 62 Hz. Additional camera pairs can be added to accommodate athletic movement such as sidestepping. Additional camera pairs can be added to accommodate interlaced capture and frame rates of up to 200 Hz.

An embodiment of the present invention can include a feature of creating a color texture by adding an additional color camera for each pair of monochrome cameras. In this case, the trigger box can alternate the speckle pattern with panel LED light sources built into the frame at an alternating on-off sequence (such as at 120 Hz) displaced in the range of 1 to 5 milliseconds. The sync box can then fire the respective types of cameras to match the appropriate light source at the required 3D model capture rate. The monochrome cameras will sync with the projectors and the color cameras with the LED panel. The imaging system can be constructed entirely with color cameras and achieve similar results.

Characteristics of this imaging can include: (a) each image can be taken in the range from 1 to 5 millisecond (such as at 1.5 milliseconds); (b) dynamic action (10 fps or more, such as 10 to 15 fps); (c) system can capture a slow step with (i) foot in midair, (ii) toes on a transparent surface plate, (iii) foot flat on transparent plate, and (iv) and ankle articulation; (d) software that can optimize images and obtain measurements; and (e) texture.

In some embodiments, all of the MCUs and external white light flash units are synchronized for a 1 to 5 millisecond capture window. First, the five white light speckle projectors are simultaneously triggered with the five pairs of monochrome stereo cameras. 0.1 to 1 millisecond later (such as a half millisecond later), the five color cameras are triggered in conjunction with the external white light flash units.

The capture times are governed by the speed of the step process on each side. The slower the step the more data models will be generated. A spatial sensor can be used to start and end the capture process. The software can detect the two key images for processing and these can typically be rendered in 5 to 10 seconds, with extraction of the measurements being a second or so. Generally, the episode of measurement would be less than a minute, and unusually less than 30 seconds. The system would also retain unprocessed images of the step process, which can be utilized later for additional uses.

### Use of 3D Images

In some embodiments, the information gathered can be utilized (such as at the display) to identify the products that are best suited for the participant who is being imaged. The participant can then use the system shown in FIG. 12 to search through various options, with various input and output, to make its selection. This could also be connected to internally or externally (such as via the cloud/web 1204) to locate the product from inventory and to provide pricing options.

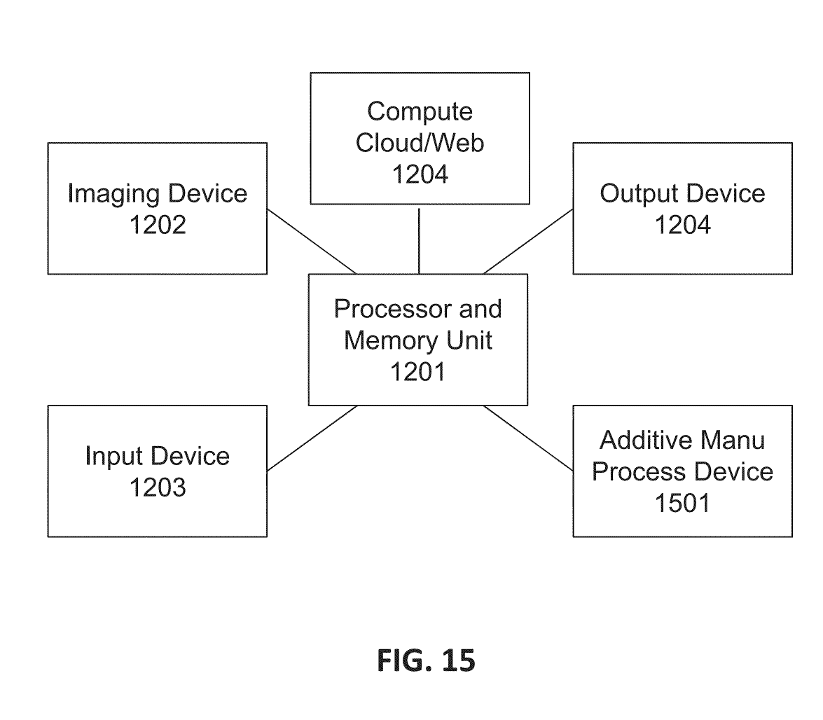

In other embodiments, the image systems provide a mechanism for the production of an article of clothing, such as footwear products. This can be done by taking the 3D image from the image system and sending it to the manufacturer for custom manufacture (such as via cloud/web 1204). Or this can be done by an individually manufactured (printed) footwear product that can be printed locally or off-site, such as shown in the embodiment of FIG. 15, which includes an additive manufacturing process device 1501 such as a 3D printing device.

In general terms, an additive manufacturing process takes virtual blueprints from computer aided design (CAD) or animation modeling software and slices them into digital cross-sections for the machine to successively use as a guideline for printing. Depending on the machine used, material or a binding material is deposited until material/binder layering is complete and the final 3D model has been printed. When printing, the 3D printing machine reads the design and lays down successive layers of liquid, powder, paper or sheet material to build the model from a series of cross-sections. These layers are joined or automatically fused to create the final shape. The fundamental advantage of additive manufacturing techniques is their ability to create almost any shape or geometric feature.

For instance, in 3D printing machines that use an extrusion deposition process (also known as Fused Filament Fabrication (FFF)), a plastic filament (typically wound on a coil and unreeled to supply material) is used and is applied through an extrusion nozzle, which regulates the flow of the molten plastic bead by controlling the filament feed rate. The extrusion nozzle heats to melt the material (or otherwise renders the material flowable). The extrusion nozzle can be moved in both horizontal and vertical directions by a computer-controlled mechanism. Alternatively, the printer platform bed may be moved relative to the extrusion nozzle, or coordinated movements of both the nozzle and platform may be used to achieve the desired extrusion path in the x, y, and z directions. The model or part is produced by extruding small beads of thermoplastic material to form consecutive layers in the vertical (i.e., z) direction. The material hardens immediately after extrusion from the extrusion nozzle. Various polymers are used in such an extrusion deposition process, including, but not limited to, the following: acrylonitrile butadiene styrene (ABS), polycarbonate (PC), polylactic acid (PLA), high density polyethylene (HDPE), PC/ABS, and polyphenylsulfone (PPSU). Generally, the polymer is in the form of a filament, fabricated from virgin resins.

Examples of additive manufacturing processes are set forth in Int'l PCT Patent Appl. Publ. No WO 2014/014977, “Systems And Methods For Manufacturing Of Multi-Property Anatomically Customized Devices,” published Jan. 23, 2014, to Tow.

The present invention thus provides a quick (and generally entertaining) user experience while collecting sophisticated data to support product development. A very accurate foot in three or four positions can be collected for every participant allowing a quite extensive database to be mined to support predicted inventory, part customization and full customized 3D printed product. Dynamic capture of 3D shapes as described above (without progressive scanning) would be utilized.

The image system of the present invention is capable of capturing a detailed model to be printed accurately and is also capable of collecting 3D data model information in multiple positions including the last and the foot on a solid surface including the underside. Further data such as ankle articulation and the mechanics of step can also be captured with a simple in store protocol (which can be input into computer 1201 using input device 1203). As described above, the system can also be reversible allowing right and left to be captured by entering the device from opposite sides.

The data collected for a customer can be maintained over time. So while it would be recommended that a customer repeats their 3D model capture immediately before ordering a fully customized product, the system can permit a consumer history to be built up.

The compact design renders the stand physically and electronic durable and reliable, which is not generally the case for existing 3D scanning technologies. Accordingly, the design of the present invention would not require extensive training of the retail store personnel or the consumer to obtain the 3D images. Present retail solutions are unsuitable in that they are using hand held scanners and structured light in the field. For such equipment, even a trained operator typically needs several attempts to get a clean model with the subject remaining completely still. Given that even if one attempt is much longer than that of the system of the present invention, the experience could last much longer (i.e., for more than a quarter hour, as opposed to less than a minute), which longer time frames would lead to frustration (and the consumer's likely abandonment of having their feet scanned). The 3D imaging technology (such as 3dMD's software) utilized in the present invention produces results on the first click.

Using embodiments of the present invention, 3D/4D printing can result in almost everything material that is being manufactured for the consumer to be manufactured locally in generic factories. Apparel production can be changes so that a consumer can have made to fit products that are matched to his or her physiological condition and personal goals at time of planned usage.

In addition to foot imaging system, the system can be used for imaging other body anatomy (for other forms of apparel). Such as:

This includes body capture using both dynamic and static systems, which can again include a portable scanning center. For instance, the system can be used for dynamic (and static) facial and torso data for use in the sale and manufacturing of consumer goods.

Body capture: both dynamic and static systems, which can again include the imaging systems described above. For instance, the system can be used for dynamic (and/or static) facial and torso data for use in the sale and manufacturing of consumer goods.

By using advanced 3D and 4D imaging in embodiments of the present invention, it is believed consumers will volunteer to be imaged in larger numbers in order to have an improved buying experience. The data collected can be used by designers/manufacturers to improve product design and providing mass-customization by tuning size and fit inventory (as well as opening up new materials and designs). Parametric models can be used to assimilate this information into a manageable form. Additionally, the point of sale/interaction devices can then be tuned to directly feed a personalized customer experience into a totally personalized 3D/4D manufacturing and fulfillment process using emergent technologies.

Breast Dynamics (Female): This would include utilization of the system with reconstructive surgeons and prosthetics to help plan interventions for those patients who have experienced a mastectomy and other treatments has been long term activity. Bio-mechanical modelling can be an important tool to utilize. Full frame rate dynamic 3D imaging will build very well where patients are imaged on a custom tilt table as they move from horizontal to vertical.

The system can also be utilized to develop apparel that provides performance and comfort for female athletes and supports the new materials and production techniques with 3D/4D based fabrication.

Hand imaging: For measuring interaction with physical objects and controls as well as calibration human-computer interface devices based on hand gesture.

Facial expression: Capture allowing a bracketing technique allowing the best aligned image to be selected from a sequence thus eliminating the need for the subject to pose for a 3D scan. This is of great value for pediatric assessment and genetic studies into facial morphology.

The examples provided herein are to more fully illustrate some of the embodiments of the present invention. It should be appreciated by those of skill in the art that the techniques disclosed in the examples which follow represent techniques discovered by the Applicant to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above.

### RELATED PATENTS AND PUBLICATIONS

The following patents and publications relate to the present invention:

U.S. Pat. No. 4,267,728, “Apparatus For Analyzing The Forces Acting On A Human Foot,” issued May 19, 1981, to Manley et al.

U.S. Pat. No. 4,600,016, “Method And Apparatus For Gait Recording And Analysis,” issued Jul. 15, 1986, to Boyd et al.

U.S. Pat. No. 5,800,364, “Foot Orthoses,” issued Sep. 1, 1998, to Glennie et al.

U.S. Pat. No. 6,205,230, “Optical Contour Digitizer,” issued Mar. 20, 2001, to Sundman et al.

Int'l PCT Patent Appl. Publ. No. WO 2013/113769, “Method And Device For Evaluating A Contact Area Between A Foot And Surface,”published Aug. 8, 2013 to Becker et al.

Int'l PCT Patent Appl. Publ. No. WO 2014/014977, “Systems And Methods For Manufacturing Of Multi-Property Anatomically Customized Devices,” published Jan. 23, 2014, to Tow.

R. P. Betts, “Static and Dynamic Foot-Pressure Measurements In Clinical Orthopedics,” Medical and Biological Engineering and Computing, 1980, 18(5), 674-684.

The disclosures of all patents, patent applications, and publications cited herein are hereby incorporated herein by reference in their entirety, to the extent that they provide exemplary, procedural, or other details supplementary to those set forth herein.

What is claimed is:

1. A system comprising:
(a) an imaging system comprising a plurality of modular camera units, wherein each modular camera unit comprises a first machine vision camera, a second machine vision camera, and a projector to provide light;
(b) a processor coupled to the imaging system,
(c) a memory unit operable for storing an imaging computer program for operating the imaging system, wherein the imaging computer program comprises the steps of
(i)sending and receiving signals to control each of the plurality of modular camera units as an object passes before the imagining system to generate stereo images of the object obtained from both of the first machine vision camera and the second machine vision camera of the modular camera unit while controlling the light emitted from the projector of the modular camera unit, wherein
(A) the object is an anatomical portion of a person, and
(B) data to construct each 3D image is obtained by the modular camera unit in the plurality of modular camera units in the range of 0.5 to 5 millisecond;
(ii) generating stereo images from the data obtained by the plurality of modular camera units; and
(iii) performing active stereophotogrammetry to calculate a 3D surface image of the object from the generated stereo images.

2. The system of claim 1, wherein the step of performing active stereophotogrammetry calculates a sequence of 3D surface images of the object from the generated stereo images.

3. The system of claim 1, wherein the first machine vision camera is monochromatic and the second machine vision camera is monochromatic.

4. The system of claim 3, wherein at least some of the modular camera units in the plurality of modular camera units further comprise a color camera.

5. The system of claim 1, wherein the imaging system further comprises the modular camera units generates the stereo images at a stereo image generation rate of 10 to 60 frames per second.

6. The system of claim 6, wherein the stereo image generation is 10 to 15 frames per second.

7. The system of claim 1, wherein the object is a foot of the person.

8. The system of claim 7 further comprising a platform, wherein
(a) at least a portion of the platform is a transparent surface,
(b) the platform is made of one or more materials that are capable of being walked upon by the person,
(c) at least two of the plurality of modular camera units are positioned above the platform and arranged to view the foot of the person as the person walks across the platform, and
(d) at least one of the plurality of the modular camera units is positioned below the platform and arranged to view the foot of the person as the person walks across the transparent surface.

9. The system of claim 8, wherein at least four of the plurality of modular camera units are positioned above the platform and arranged to view the foot of the person as the person walks across the platform

10. The system of claim 9, wherein the at least one of the plurality of the modular camera units positioned below the platform is arranged to view the foot of the person as the person walks across the transparent surface by reflection of an angled mirror positioned below the platform.

11. The system of claim 8, wherein the imaging computer program further comprises the step of sending signals transmitting at least one 3D surface image of the object to a manufacturer to manufacture a footwear product.

12. The system of claim 8, wherein the imaging computer program further comprises the step of sending signals transmitting at least one 3D surface image of the object to an additive manufacturing process device to manufacture a footwear product.

13. The system of claim 12 further comprising an additive manufacturing processing device operatively connected to the processor, wherein the additive manufacturing process device comprises a 3D printer.

14. The system of claim 1, wherein the object is selected from the group consisting of (i) a foot, (ii) a hand, (iii), a woman's prosthetic breast, and (iv) combinations thereof.

15. The system of claim 1, wherein the imaging computer program further comprises the step of sending signals transmitting at least one 3D surface image of the object to a manufacturer to manufacture a footwear product.

16. The system of claim 1, wherein the imaging computer program further comprises the step of sending signals transmitting at least one 3D surface image of the object to an additive manufacturing process device to manufacture the footwear product.

17. The system of claim 16 further comprising an additive manufacturing processing device operatively connected to the processor, wherein the additive manufacturing process device is a 3D printer.

18. The system of claim 1, wherein the
(a) the first machine vision camera is monochromatic,
(b) the second machine vision camera is monochromatic,
(c) the projector is a white light speckle projector,
(d) each of the modular camera units in the plurality of modular camera units further comprise a color camera and an external white light flash unit, and
(e) the imaging computer program further comprises
(i)sending signals to simultaneous trigger the white light speckle projector of the modular camera unit with the first machine vision camera and the second machine vision camera of the modular camera unit, and
(ii) sending signals to simultaneous trigger the color camera and the external white light flash unit 0.1 to 2 milliseconds after the simultaneous triggering of the white light speckle projector, the first machine vision camera, and the second machine vision camera of the modular camera unit.

19. The system of claim 1, wherein the imaging system is a portable device.

20. A method comprising:
(a) directing the movement of an object across an imaging system comprising a plurality of modular camera units, wherein each modular camera unit comprises a first machine vision camera, a second machine vision camera, and a projector to provide light, wherein the object is an anatomical portion of a person;
(b) using the plurality of modular camera units to generating stereo images, wherein the data to construct each 3D image used to generate the stereo images is obtained by the modular camera units in the plurality of modular camera units in the range of 0.5 to 5 milliseconds;
(c) using the generated stereo images to perform active stereophotogrammetry and calculate a 3D surface image of the object.
